(19) United States
(12) Patent Application Publication
(10) Pub. No.: US 2019/0162418 A1
(43) Pub. Date: May 30, 2019

(54) METHOD FOR CONTROLLING A COOKING APPLIANCE USING AN EXTERNAL CONTROL UNIT, COOKING APPLIANCE AND SYSTEM

(71) Applicant: E.G.O. Elektro-Geraetebau GmbH, Oberderdingen (DE)

(72) Inventors: Christian Egenter, Bretten (DE); Marcus Frank, Sulzfeld (DE); Uwe Schaumann, Oberderdingen (DE); Kay Schmidt, Oberderdingen-Flehingen (DE)

(21) Appl. No.: 16/193,306

(22) Filed: Nov. 16, 2018

(30) Foreign Application Priority Data
Nov. 22, 2017 (DE) 10 2017 220 814.7

(51) Int. Cl. F24C 7/08; F24C 15/10; H05B 1/02; A23L 5/10

(52) U.S. Cl. CPC F24C 7/087; F24C 7/083; A23V 2002/00; H05B 1/0266; A23L 5/15; F24C 15/105

(57) ABSTRACT

In a method for controlling a cooking appliance having a heating device and an internal cooking appliance controller by means of an external control unit connected to a temperature sensor, a first step involves a plausibility check on the control commands and/or on the current operating state of the cooking appliance being performed for a temperature of a cooking vessel that has been put on. Differences for the plausibility check result in a release of power being reduced as a safety measure. A heating device controlled by the external control unit then has its power level and/or heating time period limited as the actual power and/or actual heating period when the heating device is actuated.

### FIELD OF APPLICATION AND PRIOR ART

The invention relates to a method for controlling a cooking appliance, in particular a hob or an oven, using an external control unit. In addition, the invention relates to a cooking appliance of this kind and to a system consisting of a cooking appliance and an external control unit.

The networking of electrical appliances, in particular also of cooking appliances, in private households is increasing to an ever greater extent. The aim of this is primarily to provide more opportunities to control cooking appliances using an external control unit, for example using a specific remote control, on the one hand, or a mobile terminal, on the other hand. It may thus sometimes also be rendered possible to implement new functions such as program cycles or the like by means of the external control unit that were not yet available in the cooking appliance previously. In this case, an increased safety requirement applies.

DE 19802558 A1 discloses the practice of operating a hob as a cooking appliance using a remote control as a specific external control unit.

WO 2015/055606 A2 discloses the practice of performing a self-test for an oven, which is used to ascertain whether particular functional units of the oven are working as intended. This is meant to prevent an unsafe operating state.

### Problem and Solution

The invention is based on the object of providing a method as cited at the outset, a cooking appliance and a corresponding system that are able to be used to solve problems of the prior art and, in particular, allow functionalities of a cooking appliance to be extended and user convenience to be improved and, at the same time, the assurance to be provided that user safety or dependability of the cooking appliance is achieved, with additional protection being intended to be implemented that can limit the effects of a possible fault in the external control unit or in the communication therewith during its negative effect.

This object is achieved by a method having the features of claim 1, a cooking appliance having the features of claim 25 and a system having the features of claim 26. Advantageous and preferred configurations of the invention are the subject of the further claims and are explained in more detail below. In this context, some of the features are described only for the method, only for the cooking appliance or only for the system. However, regardless of this, they are intended to be able to apply both to the method and to a cooking appliance and also to a corresponding system autonomously and independently of one another. The wording of the claims is included in the content of the description by express reference.

For the method according to the invention for controlling a cooking appliance using an external control unit, the cooking appliance has at least one heating device and an internal cooking appliance controller. Advantageously, it is a hob; it may also be an oven or a cooking appliance having at least one heating device. The internal cooking appliance controller in the cooking appliance is designed for actuating the at least one heating device and for storing a state of the cooking appliance, of the heating device and/or of the cooking vessel. This state is detected or determined on the basis of the information of an internal sensor in the cooking appliance and/or the information of the sensor of the external control unit and/or the control commands of the external control unit. Alternatively, a cooking appliance without a sensor can determine the state by virtue of the previous operation of the cooking appliance or the heating device being detected by means of information in the cooking appliance controller, for example on the basis of previous power profiles. This state is observed or monitored during the operation of the cooking appliance, and preferably it is also stored. The external control unit is arranged outside the cooking appliance, advantageously in the manner of a remote control. It gives control commands to the cooking appliance controller in order to control the cooking appliance or the at least one heating device. This allows a novel and alternative or additional operator control option to be provided in addition to an installed operator control device of the cooking appliance. Above all, however, new functionalities can be allowed to be implemented in the external control unit, which is easier than in a permanently installed cooking appliance controller.

Advantageously, at least one sensor for detecting a state of the cooking appliance, of the heating device and/or of a cooking vessel thereof may be provided, which is particularly advantageously a temperature sensor. Temperature is a very well suited measure in this case to identify a possibly critical state on the cooking appliance or in the cooking procedure.

The method has the following steps. In one step, which may be a first preceding step, a plausibility check on the control commands and/or on the current operating state of the cooking appliance is performed, that is to say, in simple terms, a check is performed to determine whether the control commands and the current operating state make sense and may actually be as such. This is aimed primarily at whether the aforementioned sensor also correctly detects a state or also detects it accurately enough. The plausibility check involves the determined state being compared with other information pertaining to a state of the cooking appliance, of the heating device and/or of the cooking vessel that is available there because it has been detected by the cooking appliance controller, or alternatively has been detected by the external control unit. It is thus possible to obtain a possible difference between the actual state, for example ascertained from the previous operation or measured using a sensor, and the desired state, ascertained from information pertaining to the state of the cooking appliance, of the heating device and/or of the cooking vessel. If the difference is not yet too great, that is to say in the event of a difference below a prescribed limit value therefor, operation of the cooking appliance can continue. If the difference is above the prescribed limit value, then operation of the cooking appliance is limited, which can be effected in different ways, preferably at least by means of reduced power from the heating device. There is then finally a problem such as, by way of example, a sensor no longer measuring sufficiently accurately or an error during the evaluation of the sensor or in the communication chain.

In a further step, which can follow the step described previously, but can also be effected beforehand, a control command of the external control unit for a desired power and/or a desired heating period is obtained or detected by the cooking appliance controller. As such, the external control unit delivers a control command for controlling the operation of the cooking appliance, either automatically from an automatic program running thereon or manually from a user.

In the event of an aforementioned difference above the limit value, the cooking appliance controller, in a subsequent step, when implementing the control command for the at least one heating device controlled by the external control unit, thus reduces a power level or heating period provided by the external control unit as the actual power level and/or as the actual heating period that is then actually used to actuate the heating device. This is because there is then probably a critical state or at least the presence thereof cannot be ruled out.

In the event of an aforementioned difference below the limit value, however, a subsequent step involves a power level or heating period accepted by the cooking appliance controller, as an implementation of the control command for power level and/or for heating period for the at least one heating device controlled by the external control unit, being directly adopted as the actual power level and/or as the actual heating period that is then actually used to actuate the heating device. There is then obviously probably no critical state, or one cannot occur soon, which means that a power prescribed by the external control unit does not need to be reduced.

It is thus possible to take account of increased safety requirements, since after all the cooking appliance is supposed to be operated using the external control unit, which just may be faulty. In one configuration of the invention, it is possible for this limiting to be performed only if the result of the plausibility check has turned out negative.

The invention can thus be used to increase safety when a cooking appliance is supposed to be operated using an external control unit, a temperature sensor advantageously being used for this operator control. It is thus possible for primarily temperature-regulated cycles to be performed using the external control unit.

It is thus possible to link external appliances as external control units to the system and, where possible, identify faulty states in the assignment of the external control unit to the heating device on which a cooking vessel is operated, in the communication between the cooking appliance and the external control unit, and also a possible malfunction in the external control unit itself and to keep the system in a safe state. As such, by way of example, temperatures in a cooking vessel can be kept below a possible ignition temperature, in particular for oil or fat, by means of internal restriction of the externally demanded power, even if the user does not do this despite monitoring called for as intended.

There may also be provision for the plausibility check to be effected after the cooking appliance controller has obtained a control command of the external control unit. Otherwise, this plausibility check would not be necessary at all without an external control command, and there would of course also be nothing that could be checked for plausibility against the current state of the cooking appliance. If the cooking appliance controller presumes or even identifies a critical state during the plausibility check, then a power requirement of the external control command can be reduced to an uncritical value or even ignored or removed. Otherwise, the power requirement of the external control command can be adopted in order to implement it as power by means of the heating device. If the external control unit has not sent a new control command over a predefined period, preferably up to 15 sec., then the internal cooking appliance controller can also independently start a fresh check.

Possible examples of external control units are operator control units designed separately from the cooking appliance that allow manual input of power grades or functions as an alternative to integrated operator control. For the most part, these are distinguished by special representational or input options that go distinctly beyond the options integrated in the cooking appliance itself. For distinction in this regard, there are external control units that can take sensors connected to them as a basis for ascertaining the power requirements for a heating device by means of a control loop. In this case, the sensors may be integrated in the cooking vessel, they can be attached thereto or they are in a foodstuff that is in the cooking vessel to be regulated. A sensor close to the foodstuff is particularly well suited to process control for a cooking process. Firstly, the external control unit may be integrated in what is known as a smart cooking vessel or can run as an app or an application on a further device such as a smartphone or a tablet computer. In all cases, the internal cooking appliance controller, after successful pairing of the external control unit and the cooking appliance controller and enabling of the external control unit by confirmation by means of a user input on the cooking appliance, for example, is provided with requirements by the external control unit for implementation by the cooking appliance. Preferably, the cooking appliance controller returns the status of the heating device, in particular the implemented power of the heating device, to the external control unit.

Generally, at least one sensor for determining the state of the cooking appliance, of the heating device and/or of the cooking vessel may be provided, wherein the internal cooking appliance controller is designed for actuating the heating device and for storing a state of the cooking appliance, of the heating device and/or of the cooking vessel on the basis of the information of the sensor and/or the control commands, in particular of the external control unit. In this case, the at least one sensor can be polled, and the result of the poll can be used in the cooking appliance controller.

Cooking appliances frequently, in particular induction hobs almost always, have a temperature sensor connected to a heating device. These temperature sensors for the most part measure the temperature of the hob surface, which is heated with a time delay by the heated cooking vessel that has been put on. Since the temperature of the cooking vessel is the critical variable for ignition of organic parts in the cooking vessel, temperature sensors are particularly suitable for assessing the state of the cooking vessel and hence as a basis for an aforementioned plausibility check. Very valuable additional information pertaining to the current temperature rise of the cooking vessel can be provided by electromagnetically measuring sensors of a heating device or by sensors that measure optically by means of thermal radiation, since these sensors, in contrast to conventional temperature sensors, provide temperature information more or less without delay.

A meaningful or advantageous plausibility check is possible even without an integrated sensor in the heating device or in the cooking appliance, as is frequently the case with radiant heaters. In this case, a limit curve, based on empirical values, for a permissible power can be defined on the basis of a previous heating period or heating energy supplied up to then, a temporary power peak preferably being permitted for essential additional heating when cold foodstuffs are identified as being added.

In a preceding step, the external control unit is advantageously assigned to the cooking appliance, referred to as “pairing” in what are known as connective systems, and the external control unit is permitted for controlling a cooking process, this being accomplished by means of an activation by the user on the operator control part of the cooking appliance, for example. Operator control of the cooking appliance preferably continues to be active so that the user can take direct action at any time to reduce power or to shut down the heating device or the whole cooking appliance.

For the plausibility check, a preferred configuration of the invention involves a temperature of the cooking vessel being used, which can be detected using the temperature sensor. An aforementioned limit value may be 50 K, preferably 25 K if accurate regulation is desired. If a temperature of the cooking vessel as detected using the temperature sensor thus differs by more than 50 K or more than 25 K from that which the cooking vessel ought to have on the basis of the previous heating that has been detected by the cooking appliance controller or by the external control unit, then there is probably a fault or a sizable inaccuracy. It is then possible to provide for the heating device to deliver only a reduced heating power, or the heating period can be limited. The desired power and/or desired heating period prescribed by the external control unit is then reduced or lowered by the cooking appliance controller.

An aforementioned plausibility check can differ from standard protective devices integrated in cooking appliances, which are based on temperature sensors integrated in the heating devices, in that a more critical check is performed in the event of power requirements or control commands of an external control unit than in the case of manual operation by means of a cooking appliance operator control device. As such, the level of protection can be raised and advantageously a power requirement from the external control unit can be restricted. By using supplementary information, this restriction of a power requirement can be lessened again or partially reversed, but never beyond an extent to which it could and would be effected in the case of a direct manual operation.

For the configuration of a plausibility check, a cooking vessel temperature can be calculated by means of a mathematical model on the basis of a measured temperature of an integrated sensor of the heating device or of the cooking appliance and its temperature change, for example. Where available, the mathematical model is also enriched by values measured without delay from electromagnetic and/or optical additional sensors. There may be provision for, in the event of a first limit value of, by way of example, 240°C. being exceeded in the calculation, the release of power to the heating device to be reduced if additionally sent sensor information of the external control unit does not show that the calculated mathematical model has calculated a temperature that is presumed to be too high. This could be the case because the external sensor information has a highly plausible and sufficiently dynamic characteristic in relation to the power supplied in the past. In this case, dynamic range is intended to be understood to mean the speed of reaction of a sensor to sudden changes of power. The permissible or permitted power is preferably reduced as temperature increases. If the value in the calculation exceeds an upper critical limit of, by way of example, 350°C., then the supply of power is interrupted in any case, especially since this second limit value is usually the same as with manual operation using the integrated cooking appliance operator control device. Advantageously, the calculation using the mathematical model can be assisted by virtue of the external control unit providing parameters of the model.

In an advantageous configuration of the invention, the cooking appliance controller can detect a state of the cooking appliance, of the heating device and/or of the cooking vessel by using at least one piece of information relating to the actual power released to the heating device, or an assumed, measured or input thermal mass of the cooking vessel along with the content. Alternatively, a temperature measured at the cooking vessel can also be used, this being particularly advantageous by means of the aforementioned temperature sensor. From this, it is then possible to calculate a temperature that should prevail at the cooking vessel. This value is then used for the aforementioned plausibility check.

The further method can involve the external control unit transmitting desired values or control commands to the cooking appliance and the cooking appliance controller periodically or at self-determined times, for example when the power requirement changes. The desired values may be power grades, power or power density, a power density being able to relate to the size of either of the heating device or the cooking vessel. Very advantageously, the external control unit can send not only the power requirement but also information pertaining to the status of the cooking vessel, for example the sensor information on the basis of which it determines or calculates the power requirement. This permits the dynamic range and hence the quality of the sensors to be rated as part of the plausibility check by the cooking appliance controller. As such, by way of example, a sensor determining the temperature of the cooking vessel bottom very quickly detects the cooking vessel temperature relevant to safety, whereas a sensor fitted in a lid sees this only partially and would identify a critical state only after a significant delay.

In a preferred development of the invention, safety can be increased by virtue of energy packets being released by the cooking appliance controller that have a stipulated energy. A power level and/or a heating period are determined in this case with reciprocal influencing, these being dependent on the stipulated energy or size of the released energy packet. If the power is high, then the heating period is short, however, and vice versa. This can reduce the risk of a dangerous state that could arise on the cooking appliance. These energy packets can thus be released by the cooking appliance controller, in which case they are more or less freely available to the external control unit without the cooking appliance controller needing to watch over details of their use or exact split.

There may be provision for consumption of one energy packet by the cooking appliance controller to be followed by a new energy packet of the same level being released only if an aforementioned difference is below the limit value. This difference is thus again detected or determined as part of the plausibility check, and this is taken as a basis for controlling the further method.

Alternatively, there may be provision for a difference below the limit value to result in multiple energy packets being released by the cooking appliance controller, each with stipulated energy, in particular energy packets of the same size. In this case, the energy packets can have a variable power level during consumption. Consumption of one energy packet is then automatically followed by the next energy packet being released in this case. A fresh plausibility check is then not required. It is thus possible for all released energy packets to be consumed. If a new successful plausibility check does not then ensue, the heating device can subsequently be shut down or now operated just at a low power level, preferably no more than 25% of the maximum power or no more than 2.2 W/cm², in particular 1.5 W/cm². Therefore, a regular plausibility check is recommended so as then to have a new energy packet released again each time all the energy packets have been consumed.

In the event of a plausibility check not being passed and a difference being above the limit value, the cooking appliance can either be switched off, or alternatively a power level can be lowered to a level that is permanently uncritical for the operation of the heating device, in particular with the cooking vessel put on. It is thus possible to obtain at least one keep warm function, even if full operation of the cooking appliance at the heating power produced previously would no longer be safe enough.

In one configuration of the invention, a dynamic range of a sensor that preferably follows a change of power of a heating device can allow a check to determine how the sensor signal changes on the basis of a power supplied to the heating device. A dynamic range ascertained in this manner can be taken as a basis for determining a maximum permissible power at which the heating device can heat a cooking vessel without there being a risk of overheating or excessive temperature as a dangerous state. Depending on the dynamic range, different powers can be permitted by the cooking appliance controller. This is because a high dynamic range results in the temperature sensor reacting quickly, that is to say that there is a fast controlled system that would quickly identify even excessively high temperatures in order to lower a power. A quickly arising critical situation can still be identified and averted quickly enough and in good enough time.

The high dynamic range with a quickly rising or quickly variable sensor signal can result in the cooking appliance controller permitting a high power, preferably 50% to 100% of the maximum power. A low dynamic range with a slowly rising sensor signal can result in the cooking appliance controller permitting only a low power on the other hand, preferably up to 40% or only up to 20% of the maximum power.

There may be provision for a further step, which is then a checking step, to involve a specific power trend that can and should differ from a preset of the external control unit being taken with the heating device. This difference can range from 20% to 200% of the prescribed power, that is to say may sometimes even be very large. As such, a reactive response by a regulator in the cooking appliance controller is supposed to be caused, that is to say also a change of state at the sensor. The time that elapses before this reactive response ensues can be taken as a basis for estimating a dynamic range of a control loop. A low dynamic range exists if the time before the reactive response ensues is long. On the other hand, a high dynamic range exists if the time before the reactive response ensues is short. Therefore, the aforementioned difference can also be chosen to be very large so that the reactive response can in fact also be very fast if the given dynamic range so permits.

In one configuration of the invention, if there is no reactive response within a predefined time in the checking step described above, a safety function can be caused or triggered, in which case the power can be reduced or best of all terminated by the cooking appliance controller. Alternatively, it is also possible for other additional safety measures to be taken such as signaling to a user.

In one development of the invention, if there are no signals from sensors of the external control unit, a maximum permissible power is limited by the cooking appliance controller as a safety function. This can be effected on the basis of a state or a change of state of detection means or sensors directly connected to the cooking appliance controller, preferably by a temperature sensor and/or a temperature detection means on the heating device or on the cooking vessel. This is because a transmission path between the external control unit and the sensors or the cooking appliance controller may then be subject to interference or interrupted entirely, which means that no further or no further relevant control commands can come from the external control unit. This is because the control unit probably lacks relevant state information.

In one configuration of the invention, there may be provision for the external control unit to be a remote control or to be used as a remote control. The remote control then has standard operator control elements, in particular keys for power adjustment. A remote control of this kind can advantageously be connected to the cooking appliance controller by means of a radio link, in particular by means of WLAN, ZigBee, Bluetooth or BLE. Alternatively, it could be an IR connection, which would be more susceptible to interference, however, and requires a direct line of sight. A remote control of this kind may, in a first variant, advantageously be designed only for operation as a manual control unit, that is to say more or less as an external operator control device that can be taken a certain distance away from the cooking appliance. However, it can no longer perform functions as are possible on the cooking appliance itself

In a second variant, a remote control of this kind may be of more sophisticated design and have automatic programs or the like, which means that it may then also be in the form of an automatic control unit and can operate as such, preferably in addition to possible operation with purely manual operation, that is to say as a manual control unit. A distinction is important for an external control unit of this kind, since an automatic control unit is intended to involve automatic or cooking programs running without a user constantly standing beside it or performing control. A potentially unsafe or dangerous situation can then quickly get out of control with an automatic program if the sensors thereof or a data transmission no longer operate correctly and reliably. This needs to be prevented.

In a further configuration of the invention, the external control unit is a mobile terminal such as a smartphone, PDA or a tablet computer. A sophisticated or complex, so to speak, external control unit of this kind may also be connected to the cooking appliance controller by means of an aforementioned radio link using WLAN, ZigBee, Bluetooth or BLE. The mobile terminal can perform a temperature regulation directly or using an app running thereon in order to prescribe a heating power for the heating device by means of control commands as automatic programs. It is thus possible for determined power profiles to be actuated over time. Therefore, a mobile terminal of this kind is frequently at least also used and classified as an automatic control unit, it also being possible, as with a remote control as described above, to deliver only manual control commands.

The aforementioned automatic programs may, in one configuration of the invention, be designed such that they prescribe or provide the cooking appliance controller with power/time profiles as control commands. An automatic control unit is much more convenient if, in one configuration of the invention, the external control unit is connected to a temperature sensor, that is to say that a temperature sensor is present. It is then possible for not just a power profile to be prescribed, but rather a regulated temperature profile. Similarly, a temperature can easily just be kept constant. Above all, this temperature sensor is advantageous for calculating a limit value for the plausibility check because the temperature when cooking is the primary critical measure both for a good cooking result and for the purposes of this method with the prevention of critical states in the event of errors in the remote control by the external control unit. Critical or even dangerous states other than an excessively high temperature cannot actually arise for the safety measures under consideration here.

A temperature sensor is advantageously wirelessly connected to the external control unit by means of a radio link, advantageously an aforementioned radio link. For a hob as the cooking appliance, the temperature sensor may be arranged on a cooking utensil or may be integrated in a cooking utensil. Alternatively, it could be in the form of a spit for use in an oven. Temperature sensors for arrangement on a cooking vessel are known fundamentally in the prior art. Using a temperature sensor of this kind, the external control unit can actuate a regulated temperature profile or undertake a temperature regulation for the cooking utensil and, to this end, prescribe a power regulation for the heating device of this cooking utensil for the cooking appliance controller.

Alternatively, the external control unit itself can have a temperature sensor and may also itself be arranged on a cooking utensil or may be integrated in a cooking utensil. In that case, it is advantageously in the form of a remote control. In this case, the external control unit is particularly advantageously designed as an automatic control unit, and detection of the temperature by the external control unit itself actually principally then makes sense, of course. Sometimes, the temperature sensor may also be directly connected to the cooking appliance or can send its signals thereto.

A cooking appliance and an external control unit can together form a system according to the invention. In this case, there may be provision for difference external control units to be able to operate together with a cooking appliance, so that it is possible to select external control units having different capabilities and user convenience. Retrofitting is also possible in this manner. A cooking appliance according to the invention may then in fact be prepared therefor; in particular, the cooking appliance controller is specifically designed to communicate with an external control unit. The specific method for checking the control commands and/or the current operating state of the cooking appliance is performed in the cooking appliance controller, for which purpose the cooking appliance controller is specifically designed. In this case, the cooking appliance controller also performs the previously described plausibility check.

These and further features emerge not only from the claims but also from the description and the drawing, wherein the individual features are in each case implemented in their own right or in combinations of two or more in the form of subcombinations for an embodiment of the invention and in other fields, and may represent advantageous embodiments, as well as embodiments that are patentable in their own right, for which protection is claimed here. The division of the application into individual sections and subheadings does not restrict the generality of the statements made in these sections and under these subheadings.

Exemplary embodiments of the invention are depicted schematically in the drawing and are explained in more detail below. In this case, FIG. 1 shows a depiction of a system according to the invention with a hob as the cooking appliance according to the invention and a cellphone as the external control unit and with a temperature sensor in two possible positions.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a depiction of a system according to the invention with a hob as the cooking appliance according to the invention and a cellphone as the external control unit and with a temperature sensor in two possible positions.

### DETAILED DESCRIPTION OF THE EXEMPLARY EMBODIMENTS

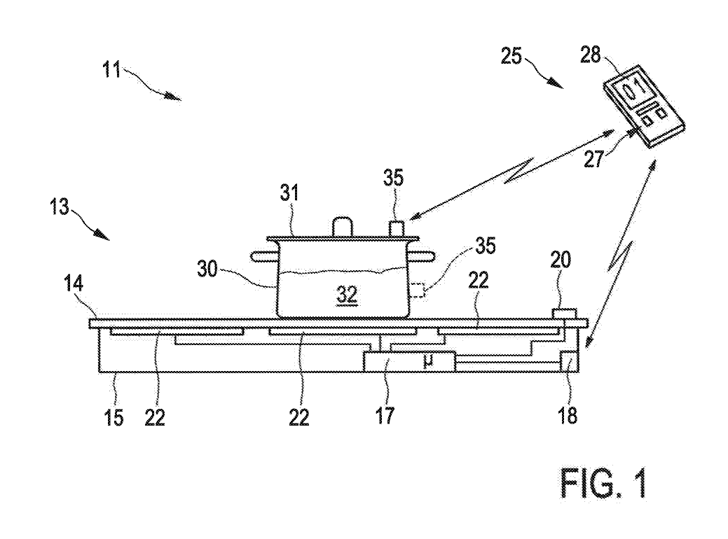

FIG. 1 shows a system 11 according to the invention that has a hob 13 as the cooking appliance according to the invention and a cellphone 25 as the external control unit. The hob 13 has an inherently standard design with a hot plate 14 and a housing 15 beneath it in which the functional units of the hob are arranged. A hob controller 17 is arranged therein, which is connected to an operator control device 20. The latter is depicted on the hob plate 14, even though it may and should be arranged beneath it in practice. The operator control device 20 has operator control elements and a display, as is known.

In addition, the hob controller 17 is connected to a radio module 18 or has such a radio module for communication with the cellphone 25. The radio module 18 can use a radio standard that the cellphone has control over, for example WLAN, ZigBee, Bluetooth or BLE. All four suffice for the ranges and distances usually desired or needed in practice. Alternatively, if instead of the cellphone another external control unit is used, then another radio standard can be used. The radio module 18 may be arranged beneath the hob plate 14 in the housing 15, sometimes directly on the underside of the hob plate 14 for the most interference-free radio transmission possible. If the cooking appliance according to the invention is an oven, then a spit advantageously used therein could be connected as an external control unit with a temperature probe to an oven controller by means of a cable, since radioing from an oven muffle is difficult. The cable connection to the oven controller would then be consistent with the radio module 18 as the communication module for the controller, in particular a plug socket on an internal wall of the oven muffle.

The hob 13 has multiple heating devices 22 in the housing that are positioned on the underside of the hob plate 14. Advantageously, these are induction heating coils 22 in this case, but there may be any type of heating device, including radiant heating devices and gas or hybrid forms thereof. The induction heating coils 22 can be operated individually or can be operated in combination as one hot plate and at a common power grade or power density, in which case they operate exactly like a single heating device for the purposes of understanding the present invention.

The cellphone 25 can be used in a manner known per se to input information or presets by means of operator control elements 27. Information can be displayed to a user on a display 28. If the cellphone 25 is a smartphone, or alternatively a tablet computer, then it can have a known touchscreen, which combines operator control elements and displays. Instead of a cellphone or tablet computer, the external control unit may also be a specific remote control, either just with operator control elements or even with automatic programs stored therein.

A central induction heating coil 22 has a cooking vessel 30 put on it with a lid 31, which contains water 32 for a cooking process, in this case, by way of example, because a user wants to cook noodles. On the lid 31, there is a temperature probe 35 arranged in a first position, for example magnetically or by clamping. The temperature probe 35 ascertains the temperature at the saucepan lid, the temperature of the water 31 being able to be determined therefrom, for example by a temperature sensor therein that is resiliently pressed against the lid 31 and has direct contact. As an alternative mounting location, the second position—depicted by dashed lines—at the bottom right on the side of the cooking vessel 30 could be used, with the advantage that here the temperature of the water 32 itself can be determined relatively directly through the wall of the cooking vessel 30. There is also good freedom from emissions for the radio connection at this location, albeit not quite as good as at the top on the lid 31. As yet a further alternative, a temperature probe 35 could also have a protruding temperature sensor that is arranged at the front on a short flexible cable, for example. This protruding flexible temperature sensor can then protrude into the cooking vessel 30 from above and be suspended in the water 32 in order to measure the water temperature directly and with maximum freedom from distortion. The temperature probe 35 could also generally have multiple temperature sensors for a distributed and better measurement. Finally, it is also possible to use a standard temperature sensor on the top of the induction heating coil. Although this temperature sensor primarily has a protective function against overheating of the induction heating coil itself or of the hob plate 14 made of glass ceramic, it can also be used for this purpose, at least for an aforementioned plausibility check.

The temperature probe 35 has a radio connection or is designed for one to an integrated radio module, not depicted, wherein a radio standard may be consistent with the radio module 18, but above all needs to be suitable for the cellphone 25. The supply of power is advantageously provided by means of an installed storage battery. The temperature probe 35 just has at least one temperature sensor, not depicted, which is advantageously in contact with the cooking vessel or the lid 31. The temperature probe 35 regularly sends signals containing the temperature information to the cellphone 25 via a radio connection. The cellphone 25 then uses this temperature information to perform an automatic program, for example, as mentioned above, for cooking noodles. This automatic program can run on an app on the cellphone 25 that also permits user inputs. These may be different, for example as a main item a selection for cooking noodles. As a subitem, a cooking time for the noodles can then be input, for example 10 min. Alternatively, this could also be detected by a camera of the cellphone 25 by means of character recognition or as more easily readable preparation information by means of QR code or the like.

After the automatic program starts, the temperature probe 35 can be used to detect the temperature of the water 31. The automatic program first of all sends control commands to the cooking appliance controller 17 via the radio module 18, said commands being implemented by the cooking appliance controller 17 as a power preset for the induction heating coils 22. To quickly boil water, the power preset will usually be very high so that the water 32 boils quickly. However, the plausibility check according to the invention now also begins. In this case, there may be provision for the cooking appliance controller 17 to detect and store the total energy passed to the induction heating coil 22. This energy is then compared with the temperature information of the temperature probe 35, which the cellphone 25 transmits to the controller for this purpose. If the measured temperature is plausible in view of the detected energy or appropriate thereto, then operation of the hob can continue without alteration. This plausibility check is performed continually, for example every 10 sec. or every 30 sec. This may be dependent on how high the desired power is, that is to say more frequently for a high desired power.

As an additional safety measure, it is possible to check whether the dynamic range of the temperature probe along with the remainder of the system is plausible or indicates that the system 11 is operating correctly. By way of example, this can be accomplished by reducing the power or briefly shutting down the induction heating coil 22 completely, for example for 10 sec. or 20 sec. The induction heating coil is then switched on again at full power. In the brief interim, the cooking vessel 30 and above all the water 32 have cooled somewhat, perhaps by 5 K. After the induction heating coil 22 is switched on full power again in this way, the temperature of the water 32 will probably rise quickly to 100° C. The cooking appliance controller 17 thus knows that in this case the dynamic range of the system is quite high. Therefore, the cooking appliance controller 17 can release the full power for the induction heating coil 22, since the control loop is closed and above all is fairly quick. If the result were a low dynamic range or a more sluggish response, then the cooking appliance controller 17 would release only a reduced power and not the full power.

The plausibility check is then repeated continually, in particular regularly. It can be performed every 10 sec. or perhaps every 30 sec. A shorter interval is regarded as not necessary, and an even longer interval would possibly be too risky.

One option for operation would in fact also be if the cooking appliance controller 17 only releases energy packets, that is to say just a release of power with a time and/or level limit. This could be appropriate above all if the plausibility check had not been passed. However, these energy packets are then proportioned such that it would probably take longer for the noodles to cook than at maximum power. The cooking appliance controller 17 can in this case also control the energy packets such that after one is used up the next is immediately provided so long as a critical situation is not discovered. Only for an unlimited and unmonitored release of power is it then not sufficient.

When the temperature probe 35 has detected that the boiling point of the water 32 has been reached, it passes this information to the cooking appliance controller 17 via the automatic program. One alternative is that the latter then generates a signal to the user or the cellphone 25 itself The user can then put the noodles into the boiling water. Another alternative is that the temperature probe 35 detects this from a distinct drop in temperature, or the user enters it into the cellphone 25. The automatic program then adjusts the temperature of the water 32, normally by reducing the power preset after one minute, to just below 100° C. on the basis of the temperature information. The user then does not need to be present for this, since the system is automatic, of course, and he also knows when the noodles will have finished being cooked. At the end of this, the power is best turned off completely and a signal is delivered to the user again. In this case, the cellphone 25 operates as an automatic control unit, since an automatic program runs on it. Alternatively, it would be easily conceivable for it to operate as a manual control unit if a user can use the cellphone 25 and a remote control, too, to input explicit and direct operator control commands that can be given to the cooking appliance controller 17 as control commands. By way of example, this would be a direct power preset, for example with power grades. In principle, a direct power preset of this kind is consistent with an input as on the operator control device 20. The cellphone 25 can thus be operated either as an automatic control unit or as a manual control unit and may then be such a unit for the cooking appliance controller 17.

The safety of operator control using the cellphone 25 and the temperature probe 35 is ensured by the plausibility check according to the invention.

1. Method for controlling a cooking appliance using an external control unit, wherein:
said cooking appliance has at least one heating device and an internal cooking appliance controller,
said external control unit is arranged outside said cooking appliance,
said external control unit is designed to give control commands to said cooking appliance controller to control at least said one heating device,
said internal cooking appliance controller is designed for actuating said heating device and for storing a determined state of said cooking appliance, of the heating device or of said cooking vessel,
wherein a state of said cooking appliance, of said heating device or of a cooking vessel thereon is determined by said cooking appliance controller, said state being observed or monitored during operation of said cooking appliance,
wherein the following steps are performed:
in one step, a plausibility check on said control commands or on said current operating state of said cooking appliance is performed, wherein said plausibility check involves said determined state being compared with other information pertaining to a state of said cooking appliance, of said heating device and/or of said cooking vessel in order to obtain a possible difference, wherein a difference below a limit value results in operation of said cooking appliance continuing and a difference above a limit value results in operation of said cooking appliance being limited,
in one step, a control command of said external control unit for desired power level or desired heating period is detected by said cooking appliance controller, said step being able to be effected before or after said other aforementioned step, and
in an event of said difference being below said limit value, a subsequent step involves a power level or heating period accepted by said cooking appliance controller, as an implementation of said control command for power level or for heating period for said at least one heating device controlled by said external control unit, being directly adopted as an actual power level and/or as an actual heating period being then used to actuate said heating device,
in an event of said difference being above said limit value, said cooking appliance controller, in a subsequent step, when implementing said control command for said at least one heating device controlled by said external control unit, reduces a power level or heating period provided by said external control unit as said actual power level or as said actual heating period being then used to actuate said heating device.

2. Method according to claim 1, wherein a preceding step involves said external control unit being assigned to said cooking appliance or to said heating device.

3. Method according to claim 2, wherein said preceding step involves said external control unit being assigned to said cooking appliance or said heating device together with activation or confirmation by a user at said cooking appliance in order to permit external control of a cooking process using said external control unit.

4. Method according to claim 1, wherein at least one sensor for determining a state of said cooking appliance, of said heating device or of said cooking vessel is provided, wherein said internal cooking appliance controller is designed for actuating said heating device and for storing a state of said cooking appliance, of said heating device or of said cooking vessel on a basis of said information of said sensor or said control commands of said external control unit, said at least one sensor being polled and said result of said poll being used in said cooking appliance controller.

5. Method according to claim 1, wherein a temperature of said cooking vessel is used for said plausibility check and a limit value for a temperature difference is 50 K.

6. Method according to claim 1, wherein said cooking appliance controller detects a state of said cooking appliance, of said heating device or of said cooking vessel by using at least one piece of information of a group of:
released actual power level to said heating device,
assumed, measured or input thermal mass of said cooking vessel along with content.

7. Method according to claim 1, wherein said external control unit gives control commands to said cooking appliance controller periodically or at self-determined times.

8. Method according to claim 7, wherein said control commands include power grades, a power level or a power density, a power density relating either to a size of said heating device or to a size of said cooking vessel.

9. Method according to claim 7, wherein said external control unit gives control commands to said cooking appliance controller in an event of a change in a power requirement for said heating device.

10. Method according to claim 1, wherein if no control command comes from said external control unit for a time longer than a limit time, a fresh plausibility check on a current operating state of said cooking appliance is performed.

11. Method according to claim 1, wherein energy packets are released by said cooking appliance controller with stipulated energy, a power level or a heating period being determined with reciprocal influencing on a basis of said stipulated energy or size of said released energy packet.

12. Method according to claim 11, wherein consumption of one said energy packet by said cooking appliance controller is followed by a new energy packet of said same level being released only if a difference after performance of a plausibility check is below said limit value.

13. Method according to claim 11, wherein consumption of one said energy packet without new release of a new energy packet is followed by said heating device being shut down or now being operated only at a power level of no more than 2.2 W/cm².

14. Method according to claim 1, wherein if a plausibility check is not passed and a difference is above said limit value, said cooking appliance is either switched off or a power level is lowered to a level being permanently uncritical for an operation of said heating device.

15. Method according to claim 4, wherein a dynamic range of a sensor according to claim 4 allows a check to be performed to determine how a signal of said sensor changes on a basis of a supplied power to said heating device, a dynamic range ascertained in said manner being taken as a basis for determining a maximum permissible power level that said heating device is permitted to supply to a cooking vessel without there being a risk of overheating.

16. Method according to claim 15, wherein a high dynamic range with a quickly rising signal of said sensor results in said cooking appliance controller permitting a high power level of from 3.6 W/cm² to 10 W/cm².

17. Method according to claim 15, wherein a low dynamic range with a slowing rising signal of said sensor results in said cooking appliance controller permitting a low power level of from 0% to 50% of a maximum power level or up to 3.6 W/cm².

18. Method according to claim 15, wherein a further step, as a checking step, involves a trend in a power level that differs from a preset of said external control unit being taken with said heating device so as to cause a reactive response by a regulator in said cooking appliance controller, a time before said reactive response ensues being taken as a basis for estimating a dynamic range of a control loop, with a low dynamic range if a time before said reactive response ensues is long and with a high dynamic range if said time before said reactive response ensues is short.

19. Method according to claim 18, wherein said further step, as a checking step, involves a trend in said power level differring from a preset of said external controller by 20% to 200% of said prescribed power level being taken with said heating device.

20. Method according to claim 18, wherein if there is no reactive response within a predefined time, a safety function is caused and a power level is reduced or terminated by said cooking appliance controller or other additional safety measures are taken.

21. Method according to claim 1, wherein if there are no signals from sensors of said external control unit, a maximum permissible power level is limited by said cooking appliance controller on a basis of a change of state of detection means directly connected to said cooking appliance controller or of sensors or of sensors firmly arranged on said cooking vessel.

22. Method according to claim 1, wherein said external control unit is a remote control connected to said cooking appliance controller by means of a radio link, wherein said external control unit has a temperature sensor as remote control and is itself arranged on a cooking utensil or is integrated in a cooking utensil, said external control unit undertaking a temperature regulation for said cooking utensil and, to said end, prescribing a power regulation for said heating device of said cooking utensil for said cooking appliance controller.

23. Method according to claim 1, wherein said external control unit is a remote control connected to said cooking appliance controller by means of a radio link, wherein said external control unit is wirelessly connected to a temperature sensor by means of a radio link, said temperature sensor being arranged on a cooking utensil or being integrated in a cooking utensil.

24. Method according to claim 1, wherein said external control unit is a mobile terminal such as a smartphone or a tablet computer, said mobile terminal performing a temperature regulation directly or via an app running thereon to prescribe a heating power for said heating device by means of control commands.

25. Cooking appliance having at least one heating device and an internal cooking appliance controller, wherein said cooking appliance controller is designed to carry out a method according to claim 1.

26. System having a cooking appliance according to claim 25 and an external control unit, wherein said external control unit is designed for arrangement outside said cooking appliance and is designed to give control commands to said cooking appliance controller for controlling at least said heating device.
